(19) United States
(12) Patent Application Publication
(10) Pub. No.: US 2015/0133606 A1
(43) Pub. Date: May 14, 2015

(54) PRODUCTION METHOD FOR CURING AGENT AND/OR CURING ACCELERANT COMPLEX PARTICLES, CURING AGENT AND/OR CURING ACCELERANT COMPLEX PARTICLES, AND HEAT-CURABLE RESIN COMPOSITION

(71) Applicants: Tadashi Iwamoto, Osaka (JP); Yasuyuki Yamada, Shiga (JP); Hiroshi Yamauchi, Osaka (JP)

(72) Inventors: Tadashi Iwamoto, Osaka (JP); Yasuyuki Yamada, Shiga (JP); Hiroshi Yamauchi, Osaka (JP)

(21) Appl. No.: 14/405,031

(22) PCT Filed: Sep. 6, 2012
(86) PCT No.: PCT/JP2012/072711

§ 371 Date: Jan. 12, 2015

(51) Int. Cl. C08L 63/00

(52) U.S. Cl. CPC C08L 63/00
USPC 525/116; 264/4.1; 264/4.4; 264/4.7; 428/407; 525/122

(57) ABSTRACT

An object of the present invention is to provide a method for producing composite particles of at least one of a curing agent and a curing accelerator which have excellent release properties for at least one of the curing agent and curing accelerator, exhibit excellent rapid curability when contained in a curable resin composition, and have excellent storage stability; and the composite particles of at least one of the curing agent and the curing accelerator. Another object of the present invention is to provide to a thermosetting resin composition that contains the composite particles of at least one of the curing agent and the curing accelerator. The method of the present invention includes the steps of: preparing an emulsion in which droplets containing a compound for forming shells are dispersed in an aqueous medium; impregnating the droplets with at least one of a curing agent and a curing accelerator; and forming shells each enclosing the at least one of the curing agent and the curing accelerator.

### TECHNICAL FIELD

The present invention relates to a method for producing composite particles of at least one of a curing agent and a curing accelerator which have excellent release properties for at least one of the curing agent and the curing accelerator, exhibit excellent rapid curability when contained in a curable resin composition, and have excellent storage stability; and the composite particles of at least one of the curing agent and the curing accelerator. The present invention also relates to a thermosetting resin composition that contains the composite particles of at least one of the curing agent and the curing accelerator.

### BACKGROUND ART

Epoxy resins are used for various uses such as adhesives, sealing agents, and coating agents. To an epoxy resin are typically added a curing agent serving as a component for allowing the curing reaction to proceed and a curing accelerator serving as a component for increasing the curability. Especially for producing a stable one pack of an epoxy resin and at least one of a curing agent and a curing accelerator, a latent curing agent or curing accelerator has been often used.

Such a curing agent or a curing accelerator used for epoxy resin is exemplified by, for example, a curing agent for epoxy resins disclosed in Patent Literature 1 which has a median size of from 0.3 μm exclusive to 12 μm inclusive, contains an amine adduct as the main component, and contains from 15% exclusive to 40% inclusive of an epoxy resin curing agent having a small particle size which is defined as 0.5 times or less of the median size. Patent Literature 1 also states that it is preferred to cause a coating reaction for an epoxy resin curing agent in an epoxy resin to obtain a master-batch epoxy resin curing agent.

However, in the case that a curing agent is coated with an epoxy resin as described in Patent Literature 1, a curing agent having relatively low reactivity has to be used as the core material. Also, since a core material is coated with a thermosetting resin, expansion of the core material does not easily break the shell formed from a thermosetting resin, which unfortunately delays the curing reaction.

Patent Literature 2 discloses curing agent-containing fine particles each including a shell being a hollow fine particle of a curable epoxy resin, and a curing agent for epoxy resins which is enclosed in the hollow portion of the particle. Patent Literature 2 discloses a method for producing curing agent-containing fine particles which includes producing a suspension in which a mixture, containing an epoxy resin and an excess amount of a curing agent based on the amount of the epoxy resin, is suspended, and causing a polyaddition reaction in the suspension.

However, the curing agent-containing fine particles of Patent Literature 2 have the same problem as in Patent Literature 1 that expansion of the core material does not easily break the shell formed from a thermosetting resin, which unfortunately delays the curing reaction. Also, the auxiliary solvent added to dissolve the core material remains in the fine particles and causes a problem of voids when the fine particles are used for semiconductor bonding agents, for example.

### CITATION LIST

### Patent Literature

Patent Literature 1: JP 2007-204669 A

Patent Literature 2: JP 2006-225521 A

### SUMMARY OF INVENTION

### Technical Problem

An object of the present invention is to provide a method for producing composite particles of at least one of a curing agent and a curing accelerator which have excellent release properties for at least one of the curing agent and the curing accelerator, exhibit excellent rapid curability when contained in a curable resin composition, and have excellent storage stability; and the composite particles of at least one of the curing agent and the curing accelerator. Another object of the present invention is to provide a thermosetting resin composition that contains the composite particles of at least one of the curing agent and the curing accelerator.

### Solution to Problem

The present invention relates to a method for producing composite particles of at least one of a curing agent and a curing accelerator, including the steps of: preparing an emulsion in which droplets containing a compound for forming shells are dispersed in an aqueous medium; impregnating the droplets with at least one of a curing agent and a curing accelerator; and forming shells each enclosing the at least one of the curing agent and the curing accelerator.

The present invention is described in detail below.

The present inventors have considered preparing a mixed solution of a compound for forming shells and at least one of a curing agent and a curing accelerator dissolved in an oily solvent, dispersing droplets of the mixed solution in an aqueous solvent to obtain an emulsion, and forming shells by, for example, removing the oily solvent from the droplets, so that composite particles each enclosing at least one of the curing agent and the curing accelerator are obtained. Such a method can form into shells a thermoplastic resin easily broken by heat, and is expected to achieve both storage stability at low temperatures and high rapid curability at high temperatures.

However, such a method unfortunately gives a low volume percentage of at least one of the curing agent and the curing accelerator in the composite particles, and thus produces composite particles which have thick shells and require a long-time curing reaction. Composite particles having a low enclosure volume percentage, if mixed into a curable resin composition for example, have to be added in a large amount. Also in this case, the particles can cause an increase in the viscosity of the curable resin composition.

One way of increasing the enclosure volume percentage is, for example, to increase the mixing ratio of at least one of the curing agent and the curing accelerator to the compound for forming shells. However, many curing agents and/or curing accelerators have a high polarity, and are therefore not easily mixed with the compound for forming shells. Hence, the mixing ratio cannot be easily increased. Also, adding an excessive amount of at least one of a curing agent and a curing accelerator brings difficulties in emulsification.

Having considered solutions for these difficulties, the present inventors have found that composite particles of at least one of a curing agent and a curing accelerator which have a high enclosure volume percentage and thin shells can be produced even in the case that at least one of the curing agent and the curing accelerator has a high polarity, by preparing an emulsion in which droplets containing a compound for forming shells are dispersed in an aqueous medium, and then impregnating the droplets with at least one of a curing agent and a curing accelerator. The present inventors have then found that such composite particles of at least one of the curing agent and the curing accelerator have excellent release properties for at least one of the curing agent and the curing accelerator, exhibit excellent rapid curability when contained in a curable resin composition, and have excellent storage stability. Thereby, the present invention has been completed.

The method for producing the composite particles of at least one of a curing agent and a curing accelerator according to the present invention starts with preparing an emulsion in which droplets containing a compound for forming shells are dispersed in an aqueous medium.

The compound for forming shells may consist of a polymer for forming shells, or monomers that are materials of the compound for forming shells.

The polymer for forming shells is not particularly limited, but preferably includes a thermoplastic resin to increase the release properties of at least one of the curing agent and the curing accelerator, and more preferably includes a thermoplastic polymer having a hydrophilic group and a hydrophobic group, a polyvinyl acetal resin having a hydroxy group, and a copolymer with segments derived from acrylonitrile.

Examples of the hydrophilic group in the thermoplastic polymer having a hydrophilic group and a hydrophobic group include glycidyl groups, hydroxy groups, carboxyl groups, and sulfone groups. In particular, glycidyl groups are preferred. Examples of the hydrophobic group in the thermoplastic polymer having a hydrophilic group and a hydrophobic group include phenyl groups, methyl groups, ethyl groups, propyl groups, and methacrylic groups. In particular, phenyl groups are preferred.

Specific examples of the thermoplastic polymer having a hydrophilic group and a hydrophobic group include polystyrene derivatives and polymethacrylic acid derivatives. In particular, polystyrene derivatives are preferred.

The polystyrene derivatives are not particularly limited if they have the hydrophilic group and the hydrophobic group. Still, the polystyrene derivatives preferably have a glycidyl group as the hydrophilic group, and a phenyl group derived from a polystyrene structure as the hydrophobic group.

The weight average molecular weight of the thermoplastic polymer having a hydrophilic group and a hydrophobic group is not particularly limited, but the preferable lower limit thereof is 5000 and the preferable upper limit thereof is 100,000. A weight average molecular weight of less than 5000 may decrease the heat resistance or the solvent resistance of the resulting composite particles of at least one of the curing agent and the curing accelerator. A weight average molecular weight of more than 100,000 may excessively increase the deposition rate of the polymer for forming shells during the production, possibly failing to provide a mono-core structure to the resulting composite particles of at least one of the curing agent and the curing accelerator, or increasing the aspect ratio.

The polyvinyl acetal resin having a hydroxy group is not particularly limited, but is typically obtainable by acetalizing with an aldehyde a polyvinyl alcohol that has been obtained by saponification of polyvinyl acetate. Examples of the aldehyde used for the acetalization include formaldehyde, acetaldehyde, paraacetaldehyde, and butyraldehyde. In particular, butyraldehyde is preferred.

In the case of using the polyvinyl acetal resin having a hydroxy group as the polymer for forming shells, the physical properties of the shells can be adjusted according to the purpose by adjusting factors relating to the polyvinyl acetal resin having a hydroxy group, such as the amount of the hydroxy groups, the degree of acetalization, the amount of acetyl groups derived from the acetyl groups of the raw material which is polyvinyl acetate, and the weight average molecular weight.

The weight average molecular weight of the polyvinyl acetal resin having a hydroxy group is not particularly limited, but the preferable lower limit thereof is 5000 and the preferable upper limit thereof is 500,000. A weight average molecular weight of less than 5000 may decrease the heat resistance or the solvent resistance of the resulting composite particles of at least one of the curing agent and the curing accelerator. A weight average molecular weight of more than 500,000 may excessively increase the deposition rate of the polymer for forming shells during the production, possibly failing to provide a mono-core structure to the resulting composite particles of at least one of the curing agent and the curing accelerator, or increasing the aspect ratio. The more preferable lower limit of the weight average molecular weight of the polyvinyl acetal resin having a hydroxy group is 30,000 and the more preferable upper limit thereof is 300,000.

Commercially available products of the polyvinyl acetal resin having a hydroxy group are, for example, BL-10 (Sekisui Chemical Co., Ltd.), BL-2H (Sekisui Chemical Co., Ltd.), BM-S (Sekisui Chemical Co., Ltd.), BH-3 (Sekisui Chemical Co., Ltd.), #-3000K (DENKI KAGAKU KOGYO K.K.), and MOWITAL B60T (Kuraray Co., Ltd.).

In the case of using the copolymer with segments derived from acrylonitrile as the polymer for forming shells, the gas barrier properties and chemical resistance of the shells can be improved.

In the copolymer with segments derived from acrylonitrile, segments derived from monomers other than acrylonitrile are not particularly limited.

Examples of the other monomers include radically polymerizable monomers such as a compound having a vinyl group. Examples of the compound having a vinyl group include, but not particularly limited to, methacrylic acid esters such as glycidyl methacrylate (GMA) and methyl methacrylate (MMA), acrylic acid esters, styrene, divinylbenzene, vinylidene chloride, vinyl alcohol, vinyl pyrrolidone, ethylene glycol dimethacrylate, and butadiene. Preferred among these are styrene, glycidyl methacrylate (GMA), and methyl methacrylate (MMA).

The preferable lower limit of the weight average molecular weight of the copolymer with segments derived from acrylonitrile is 5000 and the preferable upper limit thereof is 100,000. A weight average molecular weight of less than 5000 may decrease the heat resistance or the solvent resistance of the resulting composite particles of at least one of the curing agent and the curing accelerator. A weight average molecular weight of more than 100,000 may not cause sufficient curing when the resulting composite particles of at least one of the curing agent and the curing accelerator are mixed into a curable resin composition because the shells would not be melted or decomposed by heat, and thus the composite particles could not release at least one of the curing agent and the curing accelerator.

The more preferable lower limit of the weight average molecular weight of the copolymer with segments derived from acrylonitrile is 8000, the more preferable upper limit thereof is 50,000, the still more preferable lower limit thereof is 10,000, and the still more preferable upper limit thereof is 30,000.

The polymer for forming shells may further contain an inorganic polymer. The polymer for forming shells, when containing the inorganic polymer, improves the solvent resistance of the composite particles of at least one of the curing agent and the curing accelerator, and thereby enables at least one of the curing agent and the curing accelerator to provide suitable effects even in the case that the composite particles are mixed with a solvent.

The inorganic polymer is not particularly limited, but is preferably a polymer of an organometal compound that contains at least two C1-C6 alkoxy groups per molecule and at least one metal element selected from the group consisting of Si, Al, Zr, and Ti. Examples of such a polymer of an organometal compound include silicone resin, polyborosiloxane resin, polycarbosilane resin, polysilastyrene resin, polysilazane resin, and polytitanocarbosilane resin. Among these, silicone resin is preferred, and silicone resin having a glycidyl group is more preferred.

The monomers that are materials of the compound for forming shells are not particularly limited, but are preferably monomers that are materials of a thermoplastic resin in order to increase the release properties for at least one of the curing agent and the curing accelerator. Examples of the monomers include radically polymerizable monomers such as compounds having a vinyl group (e.g. vinyl compounds, vinylidene compounds, vinylene compounds). Examples of the compounds having a vinyl group include conjugated monomers such as styrene, methyl methacrylate, methyl acrylate, acrylonitrile, ethylene glycol dimethacrylate, and p-styryl trimethoxysilane, and unconjugated monomers such as vinyl acetate, vinyl chloride, vinyl trimethoxysilane, and 3-methacryloxypropyl trimethoxysilane. These monomer species for the monomers that are materials of the compound for forming shells may be used alone or in combination.

The aqueous medium is not particularly limited, and may be, for example, an aqueous medium obtained by adding materials such as an emulsifier and a dispersion stabilizer to water.

Examples of the emulsifier include, but not particularly limited to, alkyl sulfates/sulfonates, alkylbenzene sulfonates, triethanolamine alkyl sulfates, and polyoxyethylene alkyl ethers. Examples of the dispersion stabilizer include, but not particularly limited to, polyvinyl alcohol, polyvinyl pyrrolidone, and polyethylene glycol.

Examples of the method for preparing an emulsion in which droplets containing the compound for forming shells are dispersed in an aqueous medium include a method that emulsifies a solution of the polymer for forming shells in a solvent by dispersing the solution in the aqueous medium, and a method that emulsifies the monomers that are materials of the compound for forming shells by dispersing the monomers in the aqueous medium.

Since the method for producing composite particles of at least one of a curing agent and a curing accelerator according to the present invention eliminates the need for mixing the compound for forming shells and at least one of the curing agent and the curing accelerator, an auxiliary solvent such as an alcohol is not necessary for mixing if the compound for forming shells consists of monomers. Hence, the method enables easy control of the size of the droplets containing the compound for forming shells by adjusting the mechanical sheer strength in emulsification regardless of the kind and amount used of the auxiliary solvent. Also, in the case of mixing the resulting composite particles of at least one of the curing agent and the curing accelerator into a semiconductor bonding agent, it is possible to prevent the residual auxiliary solvent from forming voids.

Here, the aqueous medium may be added to the solution of the polymer for forming shells in a solvent, or the solution of the polymer for forming shells in a solvent may alternatively be added to the aqueous medium.

Examples of the method for emulsification include stirring the mixture with a homogenizer, ultrasonic irradiation, emulsification through micro-channels or an SPG film, spraying with a spray, and the phase inversion emulsification.

Examples of the solvent include, but not particularly limited to, benzene, isoprene, hexane, heptane, cyclohexane, isobutyl formate, methyl acetate, ethyl acetate, dipropyl ether, dibutyl ether, ethanol, allyl alcohol, 1-propanol, 2-propanol, t-butyl alcohol, acetone, ethyl methyl ketone, N,N-dimethylformamide, and acetonitrile. These solvents may be used alone or in combination.

The method for producing composite particles of at least one of a curing agent and a curing accelerator according to the present invention then performs the step of impregnating the droplets containing the compound for forming shells with at least one of the curing agent and the curing accelerator.

The method for producing composite particles of at least one of a curing agent and a curing accelerator according to the present invention enables production of composite particles which have a high enclosure volume percentage and thin shells even in the case that at least one of the curing agent and the curing accelerator has a high polarity, by impregnating the droplets containing the compound for forming shells with at least one of the curing agent and the curing accelerator. This is presumably because at least one of the curing agent and the curing accelerator has a high compatibility with the droplets containing the compound for forming shells compared to the aqueous medium, and thus at least one of the curing agent and the curing accelerator, when added to a prepared emulsion, is incorporated into the droplets containing the compound for forming shells in a larger amount through mass transfer. Accordingly, in the case of mixing such composite particles of at least one of a curing agent and a curing accelerator which have thin shells into a curable resin composition, a large amount of the composite particles is not required, and thus an increase in the viscosity of the curable resin composition can be prevented.

Also, addition of at least one of a curing agent and a curing accelerator to a prepared emulsion can suppress problems such as floating of undissolved residues of at least one of the curing agent and the curing accelerator in a solid form in the vessel. Therefore, the method for producing the composite particles of at least one of a curing agent and a curing accelerator according to the present invention is regarded as a production method easily applicable to a large-sized production line.

The at least one of the curing agent and the curing accelerator is not particularly limited, but preferably has a melting point of lower than 100° C. Examples thereof include tertiary amine compounds, phosphorous catalysts, and imidazole compounds. In particular, imidazole compounds are preferred because they have excellent curability.

Examples of the imidazole compounds include, but not particularly limited to, 1,2-dimethylimidazole, 2-ethyl-4-methylimidazole, 1-benzyl-2-methylimidazole, 1-benzyl-2-phenylimidazole, 1-cyanoethyl-2-methylimidazole, 1-cyanoethyl-2-undecylimidazole, 1-cyanoethyl-2-ethyl-4-methylimidazole, 1-dodecyl-2-methyl-3-benzyl imidazolium chloride, and their adducts.

The imidazole compound is preferably a hydrophobic imidazole compound. Here, the hydrophobic imidazole compound means an imidazole compound that exhibits a concentration of lower than 5% by weight when dissolved in water in the maximum amount.

The hydrophobic imidazole compound is not particularly limited, but is preferably an imidazole compound having a C11 or higher hydrocarbon group. Examples of the imidazole compound having a C11 or higher hydrocarbon group include 2-undecylimidazole, 2-heptadecylimidazole, and 1-cyanoethylimidazole. Among these, 2-undecylimidazole is preferred.

Examples of the method for impregnating the droplets with at least one of the curing agent and the curing accelerator include a method that adds at least one of the curing agent and the curing accelerator in a solid form into the emulsion, heats the emulsion to the melting point or higher of at least one of the curing agent and the curing accelerator in a solid form, and liquefies at least one of the curing agent and the curing accelerator in a solid form into a liquid form. In particular, it is preferred to impregnate the droplets with at least one of the curing agent and the curing accelerator by heating the emulsion to a temperature in the range from the melting point of at least one of the curing agent and the curing accelerator in a solid form to a temperature lower than 100° C., without evaporation of the aqueous medium.

Examples of the method for impregnating the droplets with at least one of the curing agent and the curing accelerator also include a method that adds at least one of the curing agent and the curing accelerator in a liquid form into the emulsion, and stirs the emulsion.

The mixing amount of the compound for forming shells and at least one of the curing agent and the curing accelerator is not particularly limited, but the preferable lower limit of the mixing amount of at least one of the curing agent and the curing accelerator is 3 parts by weight and the preferable upper limit thereof is 16 parts by weight, relative to 7 parts by weight of the compound for forming shells. A mixing amount of at least one of the curing agent and the curing accelerator of less than 3 parts by weight may decrease the enclosure volume percentage of the resulting composite particles of at least one of the curing agent and the curing accelerator, not allowing the curing reaction to proceed sufficiently. A mixing amount of at least one of the curing agent and the curing accelerator of more than 16 parts by weight may fail to enclose at least one of the curing agent and the curing accelerator, resulting in aggregation, or decrease the storage stability of the resulting composite particles of at least one of the curing agent and the curing accelerator.

The more preferable lower limit of the mixing amount of at least one of the curing agent and the curing accelerator is 4 parts by weight and the more preferable upper limit thereof is 7 parts by weight, relative to 7 parts by weight of the compound for forming shells.

The method for producing composite particles of at least one of a curing agent and a curing accelerator according to the present invention then performs the step of forming shells each enclosing at least one of the curing agent and the curing accelerator.

If the compound for forming shells consists of a polymer for forming shells, a method is preferred which heats the solution to remove the solvent in which the polymer for forming shells is dissolved as the method of forming shells. Thereby, shells each enclosing at least one of the curing agent and the curing accelerator can be formed by removing the solvent while separating the phase containing the polymer for forming shells and the phase containing at least one of the curing agent and the curing accelerator.

The conditions for heating are not particularly limited, but the heating is preferably performed at 30 to 70° C. Also, decompression is preferably performed in addition to the heating. The conditions for the decompression is not particularly limited, but is preferably set to a pressure of 0.095 to 0.080 MPa.

If the droplets containing the compound for forming shells contain monomers that are materials of the compound for forming shells and at least one of the curing agent and the curing accelerator is in a solid form, a method is preferred which adds into the emulsion a polymerization initiator having a ten-hour half-life temperature that is not higher than the melting point of at least one of the curing agent and the curing accelerator in a solid form, and polymerizes the monomers that are materials of the compound for forming shells as the method of forming shells. If the droplets containing the compound for forming shells contain monomers that are materials of the compound for forming shells and at least one of the curing agent and the curing accelerator is in a solid form, a method is preferred which adds, in advance, a polymerization initiator having a ten-hour half-life temperature that is not lower than the melting point of at least one of the curing agent and the curing accelerator in a solid form to droplets containing the compound for forming shells, and polymerizes the monomers that are materials of the compound for forming shells in the above step of forming shells.

The polymerization initiator is not particularly limited, but is preferably poorly soluble in water (has a solubility in water at 23° C. of 20% by weight or less). Specific examples thereof include peroxides such as benzoyl peroxide and azo compounds such as azobisisobutyronitrile. These polymerization initiators may be used alone or in combination.

The mixing amount of the polymerization initiator is not particularly limited, but the preferable lower limit thereof is 0.01 parts by weight and the preferable upper limit thereof is 20 parts by weight relative to 100 parts by weight of the monomers that are materials of the compound for forming shells. A mixing amount of the polymerization initiator of less than 0.01 parts by weight may not form composite particles of at least one of a curing agent and a curing accelerator. A mixing amount of the polymerization initiator of more than 20 parts by weight hardly contributes to the reaction, and may cause bleeding out and the like.

The more preferable lower limit of the mixing amount of the polymerization initiator is 0.1 parts by weight and the more preferable upper limit thereof is 10 parts by weight relative to 100 parts by weight of the monomers that are materials of the compound for forming shells.

The method for polymerizing the monomers that are materials of the compound for forming shells is not particularly limited. The polymerization can be initiated by photoirradiation or heating, depending on the polymerization initiator used.

In the method for producing composite particles of at least one of a curing agent and a curing accelerator according to the present invention, the resulting composite particles of at least one of the curing agent and the curing accelerator are repeatedly washed with pure water, and then dried by, for example, vacuum drying.

The method for producing composite particles of at least one of a curing agent and a curing accelerator according to the present invention enables production of composite particles of at least one of a curing agent and a curing accelerator which have a high enclosure volume percentage and thin shells even when at least one of the curing agent and the curing accelerator has a high polarity. Accordingly, in the case of mixing into a curable resin composition such composite particles of at least one of the curing agent and the curing accelerator which have thin shells, a large amount of the composite particles is not required, and thus an increase in the viscosity of the curable resin composition can be prevented.

Also, if the compound for forming shells consists of monomers in the method for producing composite particles of at least one of a curing agent and a curing accelerator according to the present invention, the method enables easy control of the size of the droplets containing the compound for forming shells by adjusting the mechanical sheer strength in emulsification.

The preferable lower limit of the thickness of the shell of each composite particle of at least one of a curing agent and a curing accelerator obtained by the method for producing composite particles of at least one of a curing agent and a curing accelerator according to the present invention is 0.05 μm and the preferable upper limit thereof is 0.8 μm. A thickness of the shell of smaller than 0.05 μm may decrease the storage stability of composite particles of at least one of the curing agent and the curing accelerator. A thickness of the shell of greater than 0.8 μm may decrease the release properties of at least one of the curing agent and the curing accelerator, leading to a long-time curing reaction. The more preferable lower limit of the thickness of the shell is 0.08 μm and the more preferable upper limit thereof is 0.5 μm.

The thickness of the shell of each composite particle of at least one of the curing agent and the curing accelerator herein means the average value of thicknesses, measured with a caliper, of the shells of five composite particles randomly selected from among composite particles observed with a scanning electron microscope. The observed particles are those obtained by stirring a mixture of the composite particles in ethanol to produce capsules from which only the core materials are removed, and then polishing the capsules.

The preferable lower limit of the enclosure volume percentage of the composite particles of at least one of the curing agent and the curing accelerator obtained by the method for producing composite particles of at least one of a curing agent and a curing accelerator according to the present invention is 30 vol % and the preferable upper limit thereof is 70 vol %. An enclosure volume percentage of lower than 30 vol % may decrease the release properties of at least one of the curing agent and the curing accelerator, which may result in a long-time curing reaction or a need for a large amount of the composite particles of at least one of the curing agent and the curing accelerator. An enclosure volume percentage of higher than 70 vol % may lead to excessively thin shells of the composite particles of at least one of the curing agent and the curing accelerator, decreasing the storage stability. The more preferable lower limit of the enclosure volume percentage is 40 vol % and the more preferable upper limit thereof is 60 vol %.

The enclosure volume percentage of the composite particles of at least one of the curing agent and the curing accelerator herein means a value calculated from the following formula (1) using the volume of the composite particles calculated from the later-described average particle size and the amount of the core material determined by gas chromatography. The core material means at least one of the curing agent and the curing accelerator. Enclosure volume percentage (%)=(amount of core material (% by weight)×specific gravity of the core material (g/cm³))/volume of composite particles (cm³) (1)

The preferable lower limit of the average particle size of the composite particles of at least one of the curing agent and the curing accelerator obtained by the method for producing composite particles of at least one of a curing agent and a curing accelerator according to the present invention is 0.5 μm and the preferable upper limit thereof is 10 μm. An average particle size of smaller than 0.5 μm may decrease the storage stability of the composite particles of at least one of the curing agent and the curing accelerator when the enclosure volume percentage is maintained in the above range. An average particle size of greater than 10 μm may decrease the reliability of the cured product because when the composite particles of at least one of the curing agent and the curing accelerator are mixed into a curable resin composition, large voids may be formed after at least one of the curing agent and the curing accelerator is released by heat. The more preferable upper limit of the average particle size is 3.0 μm.

The average particle size of the composite particles of at least one of the curing agent and the curing accelerator herein means the average value of the maximum lengths, measured with a caliper, of 50 composite particles randomly selected from among composite particles observed with a scanning electron microscope at a magnification that enables observation of about 100 composite particles in one field of view.

Another aspect of the present invention is composite particles of at least one of a curing agent and a curing accelerator each including a shell that contains a thermoplastic resin and has a thickness of 0.05 to 0.8 μm, and at least one of a curing agent and a curing accelerator enclosed by the shell at an enclosure volume percentage of 30 to 70 vol %.

Yet another aspect of the present invention is a thermosetting resin composition containing a thermosetting resin and the composite particles of at least one of a curing agent and a curing accelerator according to the present invention.

### Advantageous Effects of Invention

The present invention can provide a method for producing composite particles of at least one of a curing agent and a curing accelerator which have excellent release properties of at least one of the curing agent and the curing accelerator, exhibit excellent rapid curability when contained in a curable resin composition, and have excellent storage stability; and the composite particles of at least one of the curing agent and the curing accelerator. The present invention can also provide a thermosetting resin composition containing the composite particles of at least one of the curing agent and the curing accelerator.

### DESCRIPTION OF EMBODIMENTS

The present invention is described below in more detail based on examples which, however, are not intended to limit the scope of the present invention.

### EXAMPLE 1

A polymerization reaction vessel was charged with water (1510 parts by weight), and 5% by weight polyvinyl alcohol aqueous solution (KH-20, The Nippon Synthetic

Chemical Industry Co., Ltd., 380 parts by weight) as a dispersion stabilizer, so that an aqueous medium was prepared. To the aqueous medium was added a mixed solution of divinylbenzene (16 parts by weight), trimethylolpropane triacrylate (38 parts by weight), and methacrylonitrile (MAN, Mitsubishi Materials Corporation, 16 parts by weight), whereby an emulsion was prepared. The obtained emulsion was stirred with a homogenizer at 10000 rpm, and was then put into a polymerization vessel. The emulsion was heated to 80° C., and mixed with 2-undecylimidazole (C11Z, SHIKOKU

CHEMICALS CORPORATION, solid form, melting point: 69 to 74° C., 30 parts by weight). The mixture was stirred for two hours, and then further mixed with dimethyl-2,2′-azobis(2-methylpropionate) (V-601, Wako Pure Chemical Industries, Ltd., ten-hour half-life temperature: 66° C., 0.615 parts by weight). The mixture was reacted for nine hours, so that a reaction product was obtained. The obtained reaction product was centrifuged and then dried. Thereby, composite particles of a curing accelerator were obtained.

### EXAMPLE 2

A polymerization reaction vessel was charged with water (1510 parts by weight), and 5% by weight polyvinyl alcohol aqueous solution (KH-20, The Nippon Synthetic Chemical Industry Co., Ltd., 380 parts by weight) as a dispersion stabilizer, so that an aqueous medium was prepared. To the aqueous medium was added a mixed solution of divinylbenzene (11.5 parts by weight), trimethylolpropane triacrylate (27 parts by weight), and methacrylonitrile (MAN, Mitsubishi Materials Corporation, 11.5 parts by weight), whereby an emulsion was prepared. The obtained emulsion was stirred with a homogenizer at 10000 rpm, and was then put into a polymerization vessel. The emulsion was heated to 80° C., and mixed with 2-undecylimidazole (C11Z, SHIKOKU CHEMICALS CORPORATION, solid form, melting point: 69 to 74° C., 50 parts by weight). The mixture was stirred for two hours, and then further mixed with dimethyl-2,2′-azobis(2-methylpropionate) (V-601, Wako Pure Chemical Industries, Ltd., ten-hour half-life temperature: 66° C., 0.44 parts by weight). The mixture was reacted for nine hours, so that a reaction product was obtained. The obtained reaction product was centrifuged and then dried. Thereby, composite particles of a curing accelerator were obtained.

### EXAMPLE 3

A polymerization reaction vessel was charged with water (1510 parts by weight), and 5% by weight polyvinyl alcohol aqueous solution (KH-20, The Nippon Synthetic Chemical Industry Co., Ltd., 380 parts by weight) as a dispersion stabilizer, so that an aqueous medium was prepared. To the aqueous medium was added a mixed solution of divinylbenzene (6.85 parts by weight), trimethylolpropane triacrylate (16.25 parts by weight), and methacrylonitrile (MAN, Mitsubishi Materials Corporation, 6.85 parts by weight), whereby an emulsion was prepared. The obtained emulsion was stirred with a homogenizer at 10000 rpm, and was then put into a polymerization vessel. The emulsion was heated to 80° C., and mixed with 2-undecylimidazole (C11Z, SHIKOKU CHEMICALS CORPORATION, solid form, melting point: 69 to 74° C., 70 parts by weight). The mixture was stirred for two hours, and then further mixed with dimethyl-2,2′-azobis(2-methylpropionate) (V-601, Wako Pure Chemical Industries, Ltd., ten-hour half-life temperature: 66° C., 0.265 parts by weight). The mixture was reacted for nine hours, so that a reaction product was obtained. The obtained reaction product was centrifuged and then dried. Thereby, composite particles of a curing accelerator were obtained.

### EXAMPLE 4

Composite particles of a curing accelerator were obtained in the same manner as in Example 2 except that the emulsion was stirred with a homogenizer at 5000 rpm instead of stirring the emulsion at 10000 rpm.

### EXAMPLE 5

Composite particles of a curing accelerator were obtained in the same manner as in Example 2 except that the emulsion was stirred with a homogenizer at 20000 rpm instead of stirring the emulsion at 10000 rpm.

### EXAMPLE 6

A polymerization reaction vessel was charged with water (1510 parts by weight), and 5% by weight polyvinyl alcohol aqueous solution (KH-20, The Nippon Synthetic Chemical Industry Co., Ltd., 380 parts by weight) as a dispersion stabilizer, so that an aqueous medium was prepared. To the aqueous medium was added a mixed solution of divinylbenzene (11.5 parts by weight), trimethylolpropane triacrylate (27 parts by weight), methacrylonitrile (MAN, Mitsubishi Materials Corporation, 11.5 parts by weight), and 1,1′-azobis(cyclohexane-1-carbonitrile) (V-40, Wako Pure Chemical Industries, Ltd., ten-hour half-life temperature: 88° C., 0.44 parts by weight), whereby an emulsion was prepared. The obtained emulsion was stirred with a homogenizer at 10000 rpm, and was then put into a polymerization vessel. The emulsion was heated to 80° C., and mixed with 2-undecylimidazole (C11Z, SHIKOKU CHEMICALS CORPORATION, solid form, melting point: 69 to 74° C., 50 parts by weight). The mixture was stirred for two hours, further heated to 95° C., and then reacted for nine hours, so that a reaction product was obtained. The obtained reaction product was centrifuged and then dried. Thereby, composite particles of a curing accelerator were obtained.

### EXAMPLE 7

A polymerization reaction vessel was charged with water (1510 parts by weight), and 5% by weight polyvinyl alcohol aqueous solution (KH-20, The Nippon Synthetic Chemical Industry Co., Ltd., 380 parts by weight) as a dispersion stabilizer, so that an aqueous medium was prepared. To the aqueous medium was added a mixed solution of divinylbenzene (11.5 parts by weight), trimethylolpropane triacrylate (27 parts by weight), and 3-methacryloxypropyl trimethoxysilane (Sila-Ace 5710, CHISSO CORPORATION, 11.5 parts by weight), whereby an emulsion was prepared. The obtained emulsion was stirred with a homogenizer at 10000 rpm, and was then put into a polymerization vessel. The emulsion was heated to 80° C., and mixed with 2-undecylimidazole (C11Z, SHIKOKU CHEMICALS CORPORATION, solid form, melting point: 69 to 74° C., 50 parts by weight). The mixture was stirred for two hours, and then further mixed with dimethyl-2,2′-azobis(2-methylpropionate) (V-601, Wako Pure Chemical Industries, Ltd., ten-hour half-life temperature: 66° C., 0.44 parts by weight). The mixture was reacted for nine hours, so that a reaction product was obtained. The obtained reaction product was centrifuged and then dried. Thereby, composite particles of a curing accelerator were obtained.

### EXAMPLE 8

A polymerization reaction vessel was charged with water (1510 parts by weight), and 5% by weight polyvinyl alcohol aqueous solution (KH-20, The Nippon Synthetic Chemical Industry Co., Ltd., 380 parts by weight) as a dispersion stabilizer, so that an aqueous medium was prepared. To the aqueous medium was added a mixed solution of divinylbenzene (11.5 parts by weight), trimethylolpropane triacrylate (27 parts by weight), 3-methacryloxypropyl trimethoxysilane (Sila-Ace 5710, CHISSO CORPORATION, 11.5 parts by weight), and 1,1′-azobis(cyclohexane-1-carbonitrile) (V-40, Wako Pure Chemical Industries, Ltd., ten-hour half-life temperature: 88° C., 0.44 parts by weight), whereby an emulsion was prepared. The obtained emulsion was stirred with a homogenizer at 10000 rpm, and was then put into a polymerization vessel. The emulsion was heated to 80° C., and mixed with 2-undecylimidazole (C11Z, SHIKOKU CHEMICALS CORPORATION, solid form, melting point: 69 to 74° C., 50 parts by weight). The mixture was stirred for two hours, further heated to 95° C., and then reacted for nine hours, so that a reaction product was obtained. The obtained reaction product was centrifuged and then dried. Thereby, composite particles of a curing accelerator were obtained.

### EXAMPLE 9

MARPROOF (G-1010S, partially epoxy-substituted polystyrene, NOF Corporation, 3 parts by weight) as a thermoplastic polymer having a hydrophilic group and a hydrophobic group, and a silicone resin (X-41-1053, partially epoxy-substituted alkoxy oligomer, Shin-Etsu Chemical Co., Ltd., 3 parts by weight) as an inorganic polymer were dissolved in a mixed solvent of ethyl acetate and isopropyl alcohol (IPA) (ethyl acetate:isopropyl alcohol (IPA)=6:4, 170 parts by weight), whereby a mixed solution was obtained. Into the mixed solution, water (1000 parts by weight) containing 2% by weight of polyoxyethylene lauryl ether as an emulsifier was dropped, and the mixture was stirred with a homogenizer at 3000 rpm to be emulsified. Thereafter, the obtained emulsion was heated to 60° C. with a reactor having a decompressor, mixed with 1-benzyl-2-methylimidazole (1B2MZ, SHIKOKU CHEMICALS CORPORATION, solid form, melting point: 50° C., 6 parts by weight), and then stirred for two hours. Then, the pressure was reduced at 60° C. and the mixed solvent was removed. Thereby, a reaction product was obtained. The obtained reaction product was repeatedly washed with pure water, and then dried under vacuum. Thereby, composite particles of a curing accelerator were obtained.

### COMPARATIVE EXAMPLE 1

A polymerization reaction vessel was charged with water (1510 parts by weight), and 5% by weight polyvinyl alcohol aqueous solution (KH-20, The Nippon Synthetic Chemical Industry Co., Ltd., 380 parts by weight) as a dispersion stabilizer, so that an aqueous medium was prepared. To the aqueous medium was added a mixed solution of dimethyl-2,2′-azobis(2-methylpropionate) (V-601, Wako

Pure Chemical Industries, Ltd., ten-hour half-life temperature: 66° C., 0.83 parts by weight), 2-undecylimidazole (C11Z, SHIKOKU CHEMICALS CORPORATION, solid form, melting point: 69 to 74° C., 5 parts by weight), divinylbenzene (21.75 parts by weight), trimethylolpropane triacrylate (51.5 parts by weight), and methacrylonitrile (MAN, Mitsubishi Materials Corporation, 21.75 parts by weight), whereby an emulsion was prepared. The obtained emulsion was stirred with a homogenizer at 10000 rpm, and was then put into a polymerization vessel. The emulsion was heated to 80° C. and reacted for nine hours, so that a reaction product was obtained. The obtained reaction product was centrifuged and then dried. Thereby, composite particles of a curing accelerator were obtained.

### COMPARATIVE EXAMPLE 2

A polymerization reaction vessel was charged with water (1465 parts by weight), and 5% by weight polyvinyl alcohol aqueous solution (KH-20, The Nippon Synthetic Chemical Industry Co., Ltd., 380 parts by weight) as a dispersion stabilizer, so that an aqueous medium was prepared. To the aqueous medium was added a mixed solution of dimethyl-2,2′-azobis(2-methylpropionate) (V-601, Wako Pure Chemical Industries, Ltd., ten-hour half-life temperature: 66° C., 0.615 parts by weight), 2-undecylimidazole (C11Z, SHIKOKU CHEMICALS CORPORATION, solid form, melting point: 69 to 74° C., 30 parts by weight), divinylbenzene (16 parts by weight), trimethylolpropane triacrylate (38 parts by weight), methacrylonitrile (MAN, Mitsubishi Materials Corporation, 16 parts by weight), and ethanol (5 parts by weight), whereby an emulsion was prepared. The obtained emulsion was stirred with a homogenizer at 10000 rpm, and was then put into a polymerization vessel. The emulsion was heated to 80° C. and reacted for nine hours, so that a reaction product was obtained. The obtained reaction product was centrifuged and then dried. Thereby, composite particles of a curing accelerator were obtained.

### COMPARATIVE EXAMPLE 3

MARPROOF (G-1010S, partially epoxy-substituted polystyrene, NOF Corporation, 3 parts by weight) as a thermoplastic polymer having a hydrophilic group and a hydrophobic group, a silicone resin (X-41-1053, partially epoxy-substituted alkoxy oligomer, Shin-Etsu Chemical Co., Ltd., 3 parts by weight) as an inorganic polymer, and 1-benzyl-2-methylimidazole (1B2MZ, SHIKOKU CHEMICALS CORPORATION, solid form, melting point: 50° C., 6 parts by weight) were dissolved in a mixed solvent of ethyl acetate and isopropyl alcohol (IPA) (ethyl acetate:isopropyl alcohol (IPA)=6:4, 170 parts by weight), whereby a mixed solution was obtained. Into the mixed solution, water (1000 parts by weight) containing 2% by weight of polyoxyethylene lauryl ether as an emulsifier was dropped, and the mixture was stirred with a homogenizer at 3000 rpm to be emulsified. Then, the pressure on the emulsion was reduced at 60° C. with a reactor having a decompressor, and the mixed solvent was removed. Thereby, a reaction product was obtained. The obtained reaction product was repeatedly washed with pure water, and then dried under vacuum. Thereby, composite particles of a curing accelerator were obtained.

### Evaluation

The composite particles of a curing accelerator obtained in each of the examples and comparative examples were evaluated as described below. The results are shown in Table 1.

### (1) Average Particle Size

The composite particles were observed with a scanning electron microscope (SEM) (S-3500N, Hitachi High-Technologies Corporation) at a magnification (500× to 3000×) that enables observation of about 100 composite particles in one field of view. From the obtained photograph, the maximum lengths of 50 randomly selected composite particles were measured with a caliper, and the average of the lengths was calculated.

### (2) Enclosure Volume Percentage

The enclosure volume percentage was calculated from the following formula (1) using the volume of the composite particles calculated using the above average particle size and the amount of the core material determined with a pyrolysis gas chromatograph (Q1000, JOEL Co., Ltd.). Enclosure volume percentage (%)=(amount of core material (% by weight)×specific gravity of the core material (g/cm³))/volume of composite particles (cm³) (1)

The specific gravity of the core material is 0.917 g/cm³ in the case of 2-undecylimidazole, and is 1.105 g/cm³ in the case of 1-benzyl-2-methylimidazole.

### (3) Shell Thickness

A mixture of the composite particles in ethanol was stirred at 50° C. for one day, and the core material only was removed, so that capsules were obtained. Then, the capsules were polished with a cross section polisher, and were observed with a scanning electron microscope (SEM) (S-3500N, Hitachi High-Technologies Corporation). From the obtained photograph, the thicknesses of the shells of five randomly selected composite particles were measured with a caliper, and the average of the thicknesses was calculated.

### (4) Storage Stability (Measurement of Gel Fraction)

To a mixture of an epoxy resin (jER YL980, 0.58 parts by weight) and an acid anhydride curing agent (jER YH309, 0.29 parts by weight), composite particles of a curing accelerator (0.13 parts by weight) were added. The mixture was stirred with a planetary centrifugal mixer, and the resulting epoxy resin composition was applied to a thickness of 50 μm. Thereby, a resin film was obtained.

The obtained resin film was left to stand at 40° C. for three days. Then, the film was immersed and shaken in ethyl acetate for 24 hours or longer. The immersed resin film was taken out. The weights of the resin film before and after the ethyl acetate immersion were measured, and with the weights before and after the immersion, the gel fraction was determined.

The gel fraction herein means a value obtained by dividing the weight of the resin film dried after the ethyl acetate immersion by the weight of the resin film before the ethyl acetate immersion.

### (5) Rapid Curability (Measurement of Curing Time)

To a mixture of an epoxy resin (jER YL980, 0.58 parts by weight) and an acid anhydride curing agent (jER YH309, 0.29 parts by weight), composite particles of a curing accelerator (0.13 parts by weight) were added. The mixture was stirred with a planetary centrifugal mixer, and the resulting epoxy resin composition was dropped onto a glass slide placed on a 180° C. hot plate. The time for the epoxy resin composition to be cured was measured.

### (6) Coating Liquid Viscosity

To a mixture of an epoxy resin (jER YL980, 0.58 parts by weight) and an acid anhydride curing agent (jER YH309, 0.29 parts by weight), composite particles of a curing accelerator were added to give an active amount of the core material of 0.13 parts by weight. The mixture was stirred with a planetary centrifugal mixer, and the viscosity (Pa·sec) of the mixture was measured with a cone-and-plate viscometer (VISCOMETER TV-22, TOKI SANGYO CO., LTD., φ15-mm rotor was used) at 25° C. and 10 rpm.

TABLE 1

| | Monomer | | | | | | | Core material | |
|---|---|---|---|---|---|---|---|---|---|
| | (parts by weight) | | | | | Polymer | | (parts by weight) | |
| | | Trimethylol- | | | Method for | (parts by weight) | | | 1-Benzyl- |
| | Divinyl | propane | Methacrylo- | 3-Methacryloxypropyl | adding | MARPROOF | Silicone resin | 2-Undecyl | 2-methyl |
| | benzene | triacrylate | nitrile | trimethoxysilane | initiator | G-1010S | X-41-1053 | imidazole | imidazole |
| Example 1 | 16 | 38 | 16 | — | Added to | — | — | 30 | — |
| | | | | | emulsion | | | | |
| Example 2 | 11.5 | 27 | 11.5 | — | Added to | — | — | 50 | — |
| | | | | | emulsion | | | | |
| Example 3 | 6.85 | 16.25 | 6.85 | — | Added to | — | — | 70 | — |
| | | | | | emulsion | | | | |
| Example 4 | 11.5 | 27 | 11.5 | — | Added to | — | — | 50 | — |
| | | | | | emulsion | | | | |
| Example 5 | 11.5 | 27 | 11.5 | — | Added to | — | — | 50 | — |
| | | | | | emulsion | | | | |
| Example 6 | 11.5 | 27 | 11.5 | — | Preliminary | — | — | 50 | — |
| | | | | | added to | | | | |
| | | | | | droplets | | | | |
| Example 7 | 11.5 | 27 | — | 11.5 | Added to | — | — | 50 | — |
| | | | | | emulsion | | | | |
| Example 8 | 11.5 | 27 | — | 11.5 | Preliminary | — | — | 50 | — |
| | | | | | added to | | | | |
| | | | | | droplets | | | | |
| Example 9 | — | — | — | — | — | 3 | 3 | — | 6 |
| Comparative | 21.75 | 51.5 | 21.75 | — | Preliminary | — | — | 5 | — |
| Example 1 | | | | | added to | | | | |
| | | | | | droplets | | | | |
| Comparative | 16 | 38 | 16 | — | Preliminary | — | — | 30 | — |
| Example 2 | | | | | added to | | | | |
| | | | | | droplets | | | | |
| Comparative | — | — | — | — | — | 3 | 3 | — | 6 |
| Example 3 | | | | | | | | | |

| | | | Average | Enclosure | | Storage | Fast | Viscosity |
|---|---|---|---|---|---|---|---|---|
| | Method for | Emulsification | particle | volume | Shell | stability (gel | curability | of coating |
| | adding core | conditions | size | percentage | thickness | fraction) | (curing time) | liquid |
| | material | (rpm) | (μm) | (%) | (μm) | (%) | (sec) | (Ps · sec) |
| Example 1 | Immersed | 10000 | 2.0 | 32.2 | 0.21 | 2.6 | 19 | 124 |
| Example 2 | Immersed | 10000 | 2.1 | 48.3 | 0.15 | 2.8 | 16 | 101 |
| Example 3 | Immersed | 10000 | 1.7 | 64.3 | 0.12 | 4.9 | 14 | 62 |
| Example 4 | Immersed | 5000 | 7.9 | 50.1 | 0.70 | 1.0 | 21 | 69 |
| Example 5 | Immersed | 20000 | 1.4 | 46.2 | 0.10 | 3.2 | 11 | 98 |
| Example 6 | Immersed | 10000 | 1.7 | 44.3 | 0.15 | 2.8 | 17 | 78 |
| Example 7 | Immersed | 10000 | 1.9 | 49.1 | 0.16 | 3.4 | 15 | 93 |
| Example 8 | Immersed | 10000 | 1.8 | 47.4 | 0.16 | 3.1 | 17 | 68 |
| Example 9 | Immersed | 3000 | 0.6 | 35.8 | 0.10 | 14.0 | 13 | 124 |
| Comparative | Preliminary | 10000 | 1.5 | 5.6 | 0.28 | 2.6 | 78 | 212 |
| Example 1 | added to | | | | | | | |
| | droplets | | | | | | | |
| Comparative | Preliminary | 10000 | 0.5 | 15.3 | 0.05 | 31.0 | 13 | 333 |
| Example 2 | added to | | | | | | | |
| | droplets | | | | | | | |
| Comparative | Preliminary | 3000 | 0.4 | 12.2 | 0.07 | 4.7 | 71 | 273 |
| Example 3 | added to | | | | | | | |
| | droplets | | | | | | | |

### INDUSTRIAL APPLICABILITY

The present invention can provide a method for producing composite particles of at least one of a curing agent and a curing accelerator which have excellent release properties of at least one of the curing agent and the curing accelerator, exhibit excellent rapid curability when contained in a curable resin composition, and have excellent storage stability; and the composite particles of at least one of the curing agent and the curing accelerator. The present invention can also provide a thermosetting resin composition containing the composite particles of at least one of the curing agent and the curing accelerator.

1. A method for producing composite particles of at least one of a curing agent and a curing accelerator, comprising the steps of:
preparing an emulsion in which droplets containing a compound for forming shells are dispersed in an aqueous medium;
impregnating the droplets containing a compound for forming shells with at least one of a curing agent and a curing accelerator; and
forming shells each enclosing the at least one of the curing agent and the curing accelerator.

2. The method according to claim 1,
wherein the step of impregnating the droplets containing a compound for forming shells with at least one of a curing agent and a curing accelerator includes adding the at least one of the curing agent and the curing accelerator in a solid form into the emulsion, and heating the emulsion to a temperature in the range from the melting point of the at least one of the curing agent and the curing accelerator in a solid form to a temperature lower than 100° C. so as to liquefy the at least one of the curing agent and the curing accelerator in a solid form.

3. The method according to claim 1,
wherein the step of impregnating the droplets with at least one of a curing agent and a curing accelerator includes adding the at least one of the curing agent and the curing accelerator in a liquid form into the emulsion, and stirring the emulsion.

4. The method according to claim 1,
wherein the compound for forming shells consists of a polymer for forming shells.

5. The method according to claim 1,
wherein the compound for forming shells consists of monomers that are materials of the compound for forming shells.

6. The method according to claim 2,
wherein the droplets containing a compound for forming shells each contain monomers that are materials of the compound for forming shells, and
the step of forming shells each enclosing the at least one of the curing agent and the curing accelerator includes adding into the emulsion a polymerization initiator having a ten-hour half-life temperature that is not higher than the melting point of the at least one of the curing agent and the curing accelerator in a solid form, and polymerizing the monomers that are materials of the compound for forming shells.

7. The method according to claim 2,
wherein the droplets containing a compound for forming shells each contain monomers that are materials of the compound for forming shells and a polymerization initiator having a ten-hour half-life temperature that is not lower than the melting point of the at least one of the curing agent and the curing accelerator in a solid form, and
the step of forming shells each enclosing the at least one of the curing agent and the curing accelerator includes polymerizing the monomers that are materials of the compound for forming shells.

8. Composite particles of at least one of a curing agent and a curing accelerator, each comprising
a shell that contains a thermoplastic resin and has a thickness of 0.05 to 0.8 μm, and
at least one of a curing agent and a curing accelerator enclosed by the shell at an enclosure volume percentage of 30 to 70 vol %.

9. A thermosetting resin composition comprising
the composite particles of the at least one of the curing agent and the curing accelerator according to claim 8, and
a thermosetting compound.

10. The method according to claim 2,
wherein the compound for forming shells consists of a polymer for forming shells.

11. The method according to claim 3,
wherein the compound for forming shells consists of a polymer for forming shells.

12. The method according to claim 2,
wherein the compound for forming shells consists of monomers that are materials of the compound for forming shells.

13. The method according to claim 3,
wherein the compound for forming shells consists of monomers that are materials of the compound for forming shells.
